(19) United States
(12) Patent Application Publication
(10) Pub. No.: US 2012/0023081 A1
(43) Pub. Date: Jan. 26, 2012

(54) CUSTOMIZING SEARCH HOME PAGES USING INTEREST INDICATORS

(75) Inventors: Mahesh Kumar Nayak, Kirkland, WA (US); Vashutosh Agrawal, Redmond, WA (US)

(73) Assignee: MICROSOFT CORPORATION, Redmond, WA (US)

(21) Appl. No.: 12/843,324

(22) Filed: Jul. 26, 2010

(51) Int. Cl. G06F 17/30

(52) U.S. Cl. 707/706; 707/E17.108

(57) ABSTRACT

Methods and systems for utilizing images of interest to a user, so far as they relate to recent, current or upcoming events, to generate custom search engine home pages are provided. Upon receiving a request from the user to view the search engine home page, it is determined whether any indicators of the user's interests are available. If one or more interest indicators is available, the indicator(s) are compared to interest indicators (or categories of indicators) associated with recent, current and/or upcoming events to determine if there is a common interest indicator/category there between. Upon determining that there is a common interest indicator/category between one or more events and the user, a custom image is selected for presentation in association with the search engine home page based upon the common interest indicator/category. The search engine home page with the custom-selected image is then presented to the user.

### BACKGROUND

Search engine home pages do not currently customize or provide relevant information based on users recent search interests. For example, a unique image might be displayed in the background of a search engine home page that is related to a recent search query performed by a user. Currently, search engine home pages display the same images and information irrespective of a user's search interest. Search engine home pages that are not customized or relevant to a user may not hold a user's interest or inspire a user to use that particular search engine for the user's next search. Further, search engine home pages do not currently create user profiles for each search query that is performed, and associate each search query with possible user interest categories for providing relevant information to a user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, utilizing indicators of a user's interests to select custom images for presentation on a search engine home page. Upon receiving a request from the user to view the search engine home page (e.g., upon receiving user input of the search engine home page URL), it is determined whether any indicators of the user's interests are available. If one or more interest indicators is available, the indicator(s) are compared to interest indicators (or categories of indicators) associated with recent, current and/or upcoming events to determine if there is a common interest indicator/category there between. Upon determining that there is a common interest indicator/category between one or more events and the user, a custom image is selected for presentation in association with the search engine home page based upon the common interest indicator/category. The search engine home page with the custom-selected image is then presented to the user.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing system environment suitable for use in implementing embodiments of the present invention;

FIG. 2 is a schematic diagram showing a system for presenting a search engine home page customized based upon interest indicators associated with a user and event information, in accordance with embodiments of the present invention;

FIG. 3 is a flow diagram showing a method for presenting a search engine home page customized based upon interest indicators associated with a user and event information, in accordance with embodiments of the present invention;

FIG. 4 is a flow diagram showing another method for presenting a search engine home page customized based upon interest indicators associated with a user and event information, in accordance with embodiments of the present invention; and

FIG. 5 is an exemplary user interface suitable for use in association with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, providing search home pages customized with images of interest to a user so far as they relate to recent, current or upcoming events. Upon receiving a request from the user to view the search engine home page (e.g., upon receiving user input of the search engine home page URL), it is determined whether any indicators of the user's interests are available. If one or more interest indicators is available, the indicator(s) are compared to interest indicators (or categories of indicators) associated with recent, current and/or upcoming events to determine if there is a common interest indicator/category there between. Upon determining that there is a common interest indicator/category between one or more events and the user, a custom image is selected for presentation in association with the search engine home page based upon the common interest indicator/category. The search engine home page with the custom-selected image is then presented to the user.

Accordingly, in one embodiment, the present invention is directed to one or more computer-readable storage media storing computer-useable instructions that, when used by one or more computing devices, cause the one or more computing devices to perform a method for utilizing interest indicators associated with users to customize search engine home pages. The method comprises receiving an indication that a user desires to access a search engine home page and comparing one or more interest indicators associated with the user with a plurality of scheduled events. Each of the plurality of scheduled events has at least one interest category associated therewith, and the interest indicator(s) associated with the user are organized into one or more interest categories. The method further comprises selecting an image for presentation in association with the search engine home page, the image being selected based upon a common interest category of both the at least one interest category associated with one of the plurality of scheduled events and the one or more interest categories associated with the one or more interest indicators associated with the user.

In another embodiment, the present invention is directed to a system for presenting search engine home pages customized based upon interest indicators associated with users. The system comprises a computing device associated with one or more processors and one or more computer-readable storage media; a data store coupled with the computing device; and a search engine. The search engine receives an indication that a user desires to access a home page associated with the search engine, compares one or more interest indicators associated with the user with a plurality of scheduled events to determine at least one common interest category there between, and selects an image for presentation in association with the search engine home page, the image being selected based upon the at least one common interest category. Generally, the data store comprises historical search information associated with the user; an event catalog that includes the plurality of scheduled events, each scheduled event having one or more associated interest categories; and a plurality of images configured for presentation in association with the search engine home page, each of the images being associated with one or more interest categories.

In yet another embodiment, the present invention is directed to one or more computer-readable storage media storing computer-useable instructions that, when used by one or more computing devices, cause the one or more computing devices to perform a method for utilizing interest indicators associated with users to customize search engine home pages. The method comprises receiving an indication that a user desires to access a search engine home page; determining that one or more interest indicators associated with the user are available; determining one or more interest categories for the user based upon the one or more interest indicators; and comparing the one or more interest categories for the user with an event catalog, wherein the event catalog includes a plurality of events, each of the plurality of events being associated with at least one interest category. The method further includes determining that one of the one or more interest categories for the user and one of the at least one interest categories associated with one of the plurality of events is a common interest category, and selecting an image for presentation in association with the search engine home page. The image is selected based upon the common interest category.

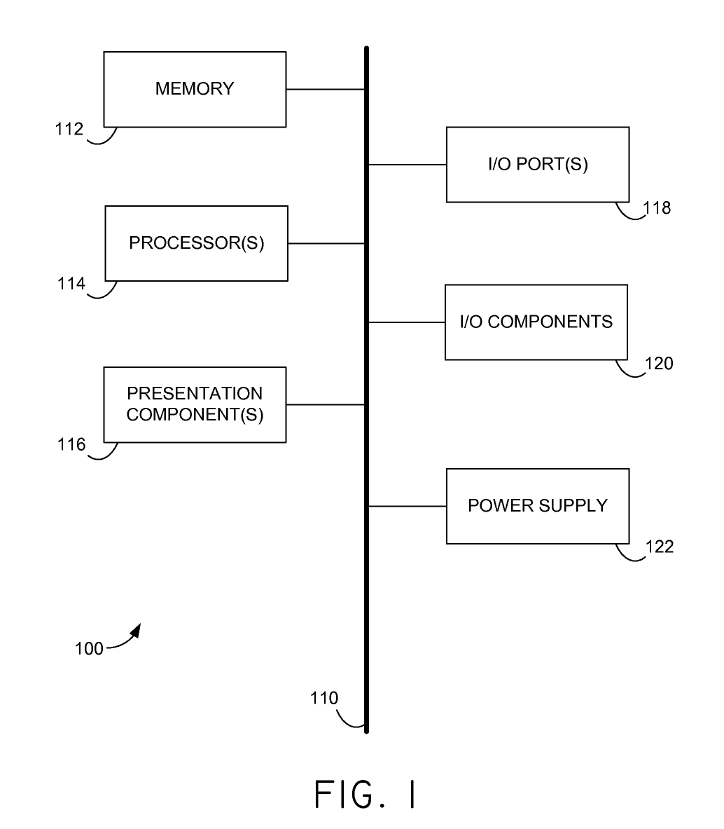

Having briefly described an overview of embodiments of the present invention, an exemplary operating environment in which embodiments of the present invention may be implemented is described below in order to provide a general context for various aspects of the present invention. Referring initially to FIG. 1 in particular, a block diagram illustrating an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” and the like, as all are contemplated within the scope of FIG. 1 and reference to “computing device.”

The computing device 100 typically includes a variety of computer-readable media. Computer-readable media can be any available media capable of being accessed by the computing device 100 and includes both volatile and nonvolatile media, removable and non-removable media. By way of example, and not limitation, computer-readable media may comprise computer-storage media and communication media, the two being mutually exclusive of one another. Computer-storage media includes volatile and nonvolatile, removable and non-removable media implemented in any method or technology for storage of information such as computer-readable instructions, data structures, program modules or other data. In this way, computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O component(s) 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O component(s) 120, some of which may be built in. Illustrative components include a microphone, joystick, game pad, satellite dish, scanner, printer, wireless device, and the like.

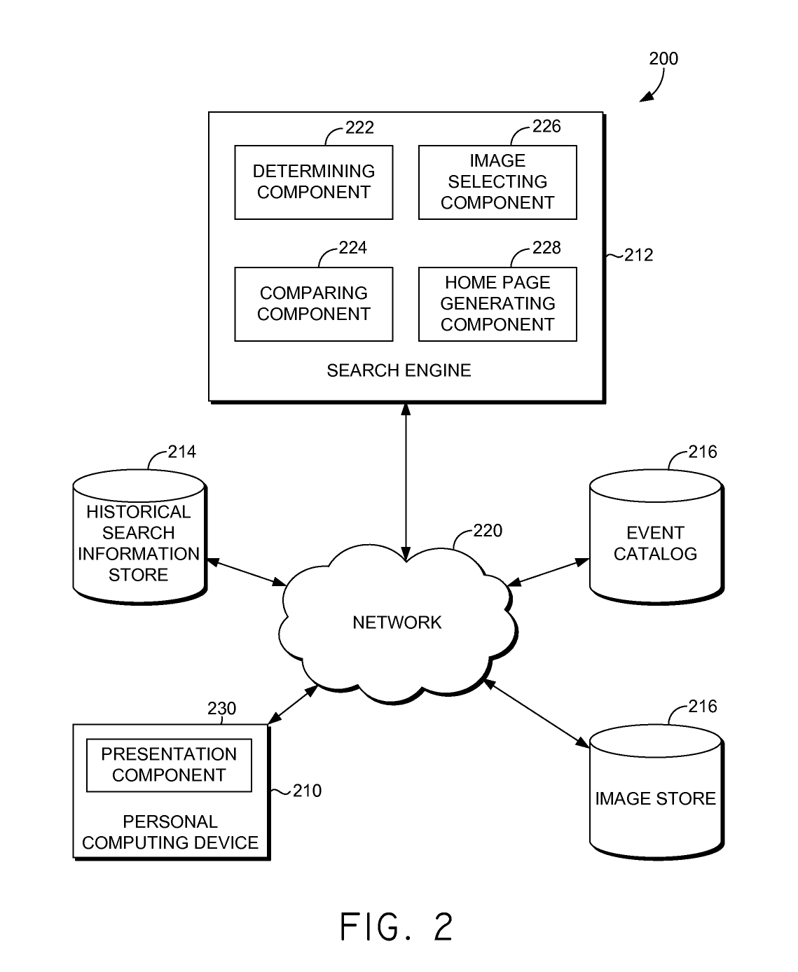

As indicated previously, embodiments of the present invention are directed to utilizing interest indicators associated with users to customize search engine home pages with images of interest to particular users so far as they relate to recent, current and/or upcoming events. Turning now to FIG. 2, a block diagram is provided illustrating an exemplary computing system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the computing system 200 generally includes a personal computing device 210, a search engine 212, an historical search information store 214, an event catalog 216, and an image store 218. The personal computing device 210 may include any type of computing device, such as computing device 100 described with reference to FIG. 1, for example. The search engine 212 may take the form of a dedicated device for performing the functions described below; may be integrated into, e.g., the personal computing device 210, a network access device, or the like; may be an Internet-based service; may be provided as a module inside a multi-purpose engine; or any combination thereof. The components of the computing system 200 may communicate with each other via a network (e.g., network 220), which may include, without limitation, one or more local area networks (LANs) and/or wide area networks (WANs). Such networking environments are commonplace in offices, enterprise-wide computer networks, intranets and the Internet.

The historical search information store 214 is configured to store information, for instance, associated with users' prior search behavior. Such information may include, without limitation, user identifiers, associated user interest indicators (e.g., prior user-input search queries and/or prior search query result selection behavior), associated interest categories (as more fully described below), and the like. In embodiments, the historical search information store 214 is configured to be searchable for one or more of the user interest indicators and/or associated interest categories.

The event catalog 216 is configured to store information, for instance, associated with recent, current or upcoming events. Such events may be on a global scale or local scale, as desired, and may be limited by time. For instance, merely by way of example, only information pertaining to prior events from the past twenty-four hours, current events, and future events scheduled to take place in the next ten days may be stored in the event catalog 216. Each event having information stored in the event catalog 216 includes at least one interest category associated therewith. In embodiments, the information stored in association with the event catalog 216 is configured to be searchable.

The image store 218 is configured to store images (or reference links thereto), each image having one or more interest categories associated therewith. Each of the stored images is associated with a particular event related to the interest category(ies) associated therewith. For example, if the interest category associated with a particular image is “running” and the time of year is near the New York City Marathon, then the image might be a picture from a prior New York City Marathon. In embodiments, the information stored in association with the image store 218 is configured to be searchable.

It will be understood and appreciated by those of ordinary skill in the art that the information stored in the historical search information store 214, the event catalog 216, and/or the image store 218 may be configurable and may include any information relevant to recent, current or upcoming events, user search behaviors, and the like. The content and volume of such information are not intended to limit the scope of embodiments of the present invention in any way. Further, though illustrated as three, independent components, the historical search information store 214, the event catalog 216 and the image store 218 may, in fact, be a single data store, and/or may have portions which reside on a server (not shown), the personal computing device 210, another external computing device (not shown) and/or any combination thereof.

It should be understood that any number of personal computing devices, search engines and data stores (e.g., historical search information store 214, event catalog 216 and image store 218) may be employed in the computing system 200 within the scope of embodiments of the present invention. Each may comprise a single device/module or multiple devices/modules cooperating in a distributed environment. For instance, the search engine 212 may comprise multiple devices and/or modules arranged in a distributed environment that collectively provide the functionality of the search engine 212 described herein. Additionally, other components/modules not shown may also be included within the computing system 200.

In some embodiments, one or more of the illustrated components/modules may be implemented as stand-alone applications. In other embodiments, one or more of the illustrated components/modules may be implemented via the personal computing device 210, as an Internet-based service, or as a module inside a multi-purpose search engine. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of servers or client computing devices. By way of example only, the image selection component 218 (more fully described below) might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Generally, the computing system 200 illustrates an environment in which search engine home pages may be customized based upon user interest indicators and event information. As will be described in further detail below, embodiments of the present invention provide users with a meaningful search experience designed to persuade users to frequent the search engine. As the search engine home page is customized based upon the user's interests (as evidenced by the user's interest indicators) and recent, current or upcoming event information, the user is enticed to access the search engine frequently to see if an image of interest to them is presented. Additionally, embodiments of the present invention permit hotspots to be incorporated into the custom search engine home page, activation of which may present trivia, facts, or other information related to the image and/or associated interest categories, which may also further entice and engage the user.

With continued reference to FIG. 2, the search engine 212 includes a determining component 222, a comparing component 224, an image selection component 226, and a home page generating component 228. Upon receiving an indication that a user desires to access a search engine home page (e.g., upon receiving user-input of a search engine home page URL), the determining component 222 is configured to determine whether one or more interest indicators associated with the user is available. Such determination may be made utilizing metadata conveyed, for example, via one or more of the user's IP address, a session ID, and a cookie associated with the user, and may be based upon one or more of historical search information associated with the user (i.e., the user's prior search behavior), information available from a profile associated with the user, etc. Additionally, one or more predictive models may be utilized to predict future search behavior of the user for use in determining interest indicators. Interest indicators may be conveyed in conjunction with the indication that the user desires to access the search engine home page and/or from the historical search information store 214.

Upon determining that one or more interest indicators associated with the user is available, the determining component 222 may be configured to organize the interest indicator(s) into one or more interest categories. Interest categories are simply categories into which received user search queries and result selection behavior, as well as interest-identifying characteristics may be organized. Such interest categories may include, by way of example only, sports (generally or specifically), movies (generally or specifically), fashion, and the like. Naïve bayes classifiers or logistic regression, for example, may be utilized for organizing the available information (interest indicators) associated with the user into interest categories.

The comparing component 224 is configured to receive an indication of one or more interest categories into which the available user interest indicators have been organized and to compare the received interest category(ies) with interest categories associated with events listed in the event catalog 216. Upon receipt of an indication of one or more interest categories associated with the user interest indicators, the comparing component 224 is configured to compare the user-associated interest categories with the event-associated interest categories of the events having information stored in the event catalog 216 to determine whether there are any common interest categories there between. That is, the comparing component 224 is configured to determine whether there are any matches (exact or near-matches, as desired) between them.

The image selection component 226 is configured to select an image for presentation in association with the search engine home page. Upon receiving an indication (for instance, from the determining component 222) that no interest indicators associated with the user are available, or if it is determined (e.g., by the comparing component 224) that there is no common interest category between the user-associated interest categories and the event-associated interest categories, the image selection component 226 may be configured to select a default image for presentation. However, if one or more interest indicators associated with the user is available and at least one common interest category between the user-associated interest categories and the event-associated interest categories is determined, the image selection component 226 may be configured to select an image (e.g., from the image store 218) for presentation based upon the common interest category(ies) identified. In this regard, each image stored in association with the image store 218 includes one or more interest categories associated therewith and images may be selected for presentation based upon exact or near matches between the common interest category(ies) identified and the interest category(ies) associated with the stored images.

The home page generating component 228 is configured to receive a selected image (e.g., from the image selection component 226) and generate a search engine home page utilizing the selected image for presentation in response to the user's request to view the search engine home page. Again, the selected image may be a default image or may be an image selected specifically for the user. In embodiments, the home page generating component 228 is further configured to incorporate one or more hotspots into a custom (or default) search engine home page, selection of (or hovering over) which may present trivia, facts, or other information related to the image and/or any associated interest categories. The home page generating component is further configured to transmit the generated search engine home page to the personal computing device 210 (e.g., via network 220) for presentation to the user, for instance, utilizing presentation component 228. In this regard, the presentation component 228 of the personal computing device 210 is configured to present customized and/or default home pages (and associated hotspots, as appropriate) to the user.

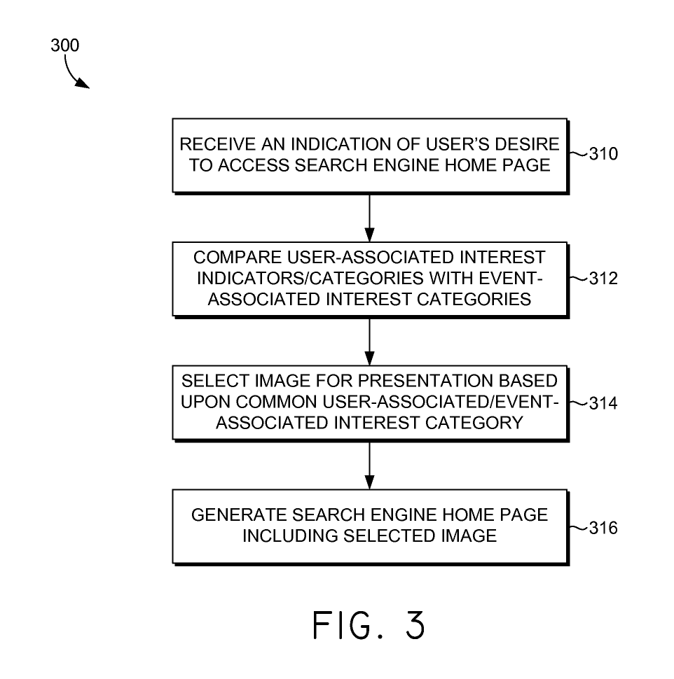

Turning now to FIG. 3, a flow diagram is illustrated showing a method 300 for utilizing interest indicators associated with users to customize search engine home pages with images relating to recent, current and/or upcoming events, in accordance with an embodiment of the present invention. As indicated at block 310, an indication is received that a user desires to access a search engine home page. For instance, user input of a search engine home page URL may be received by the search engine 212 from the personal computing device 210 of FIG. 2. The user has one or more associated interest indicators that are organized into interest categories. Additionally, the search engine (e.g., search engine 212) has access to a plurality of scheduled events (for instance, listed in event catalog 216 of FIG. 2), each of the scheduled events having at least one interest category associated therewith.

As indicated at block 312, the search engine (e.g., the comparing component 224 of the search engine 212 of FIG. 2) accesses the listed scheduled events and event-associated interest categories and compares the user-associated interest categories into which the interest indicators associated with the user are organized with the event-associated interest categories associated with the scheduled events to determine if there is a common interest category there between. Upon determining that there is a common interest category between the user-associated interest categories and the event-associated interest categories, the search engine (e.g., the image selecting component 226 of the search engine 212 of FIG. 2) selects an image (for instance, from the image store 218 of FIG. 2) for presentation based upon the common interest category(ies) identified. This is indicated at block 314.

As indicated at block 316, the search engine (e.g., the home page generating component 228 of the search engine 212 of FIG. 2) generates a search engine home page utilizing the selected image for presentation in response to the user's request to view the search engine home page. The search engine (e.g., the home page generating component 228 of the search engine 212 of FIG. 2) additionally transmits (e.g., via network 220 of FIG. 2) the generated search engine home page to a personal computing device associated with the user (e.g., personal computing device 210 of FIG. 2) for presentation (for instance, utilizing presentation component 230 of the personal computing device 210 of FIG. 2).

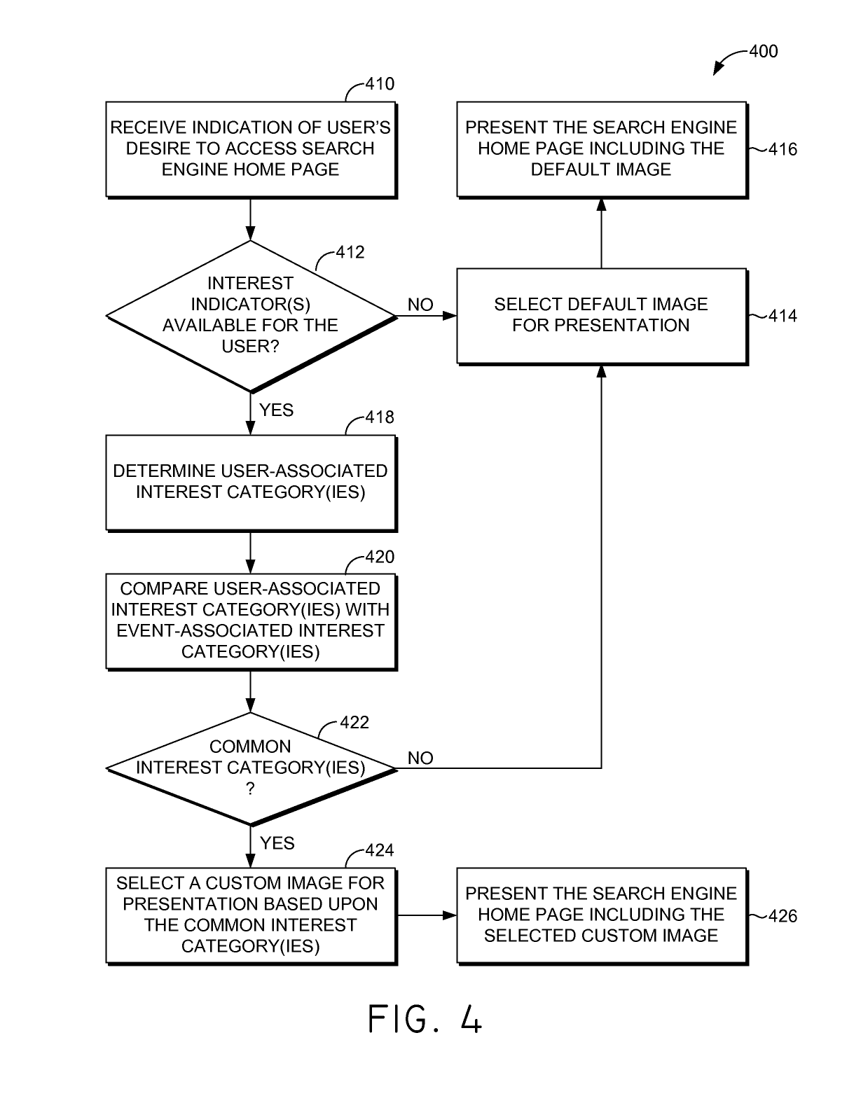

With reference to FIG. 4, a flow diagram is illustrated showing a method 400 for utilizing interest indicators associated with users to customize search engine home pages with images relating to recent, current and/or upcoming events, in accordance with an embodiment of the present invention. As indicated at block 410, an indication is received that a user desires to access a search engine home page. For instance, user input of a search engine home page URL may be received by the search engine 212 from the personal computing device 210 of FIG. 2. As indicated at block 412, it is determined (e.g., utilizing determining component 222 of FIG. 2) whether one or more interest indicators associated with the user is available. If it is determined that no interest indicators are available for the user, a default image is selected for presentation (e.g., utilizing image selecting component 226 of FIG. 2), as indicated at block 414. The search engine home page is presented to the user (for instance, utilizing presentation component 230 of the personal computing device 210 of FIG. 2), the search engine home page including the selected default image. This is indicated at block 416.

If, however, it is determined at block 412 (e.g., utilizing determining component 222 of FIG. 2) that one or more interest indicators associated with the user is available, one or more interest categories is determined for the user based upon the available interest indicator(s), as indicated at block 418. The user-associated interest categories are then compared with an event catalog (e.g., event catalog 216 of FIG. 2), the event catalog including a plurality of events stored in association therewith, each of the plurality of events having at least one associated interest category. This is indicated at block 420. Based upon the comparison, it is determined, as indicated at block 422, whether there is a common interest category between the user-associated interest category(ies) and the event-associated interest category(ies).

If it is determined that there is no common interest category between the user-associated interest category(ies) and the event-associated interest category(ies), a default image is selected for presentation (e.g., utilizing image selecting component 226 of FIG. 2), as indicated at block 414. The search engine home page is presented to the user (for instance, utilizing presentation component 230 of the personal computing device 210 of FIG. 2), the search engine home page including the selected default image. This is indicated at block 416.

If, however, it is determined at block 422 (e.g., utilizing comparing component 224 of FIG. 2) that there is a common interest category between the user-associated interest category(ies) and the event-associated interest category(ies), a custom image is selected for presentation (e.g., utilizing image selecting component 226 of FIG. 2) based upon the common interest category determined. This is indicated at block 424. The search engine home page is presented to the user (for instance, utilizing presentation component 230 of the personal computing device 210 of FIG. 2), the search engine home page including the selected custom image, as indicated at block 426.

As can be seen, embodiments of the present invention are directed to utilizing interest indicators associated with users to customize search engine home pages with images of interest to particular users so far as they relate to recent, current and/or upcoming events. It will be understood by those of ordinary skill in the art that the order of steps shown in the method 300 of FIG. 3 and the method 400 of FIG. 4 are not meant to limit the scope of embodiments of the present invention in any way and, in fact, the steps may occur in a variety of different sequences within embodiments hereof. For instance, the search engine might simultaneously access the event catalog for relevant events, as well as, access the search history store for a user's interest indicators. Any and all such variations, and any combination thereof, are contemplated to be within the scope of embodiments of the present invention.

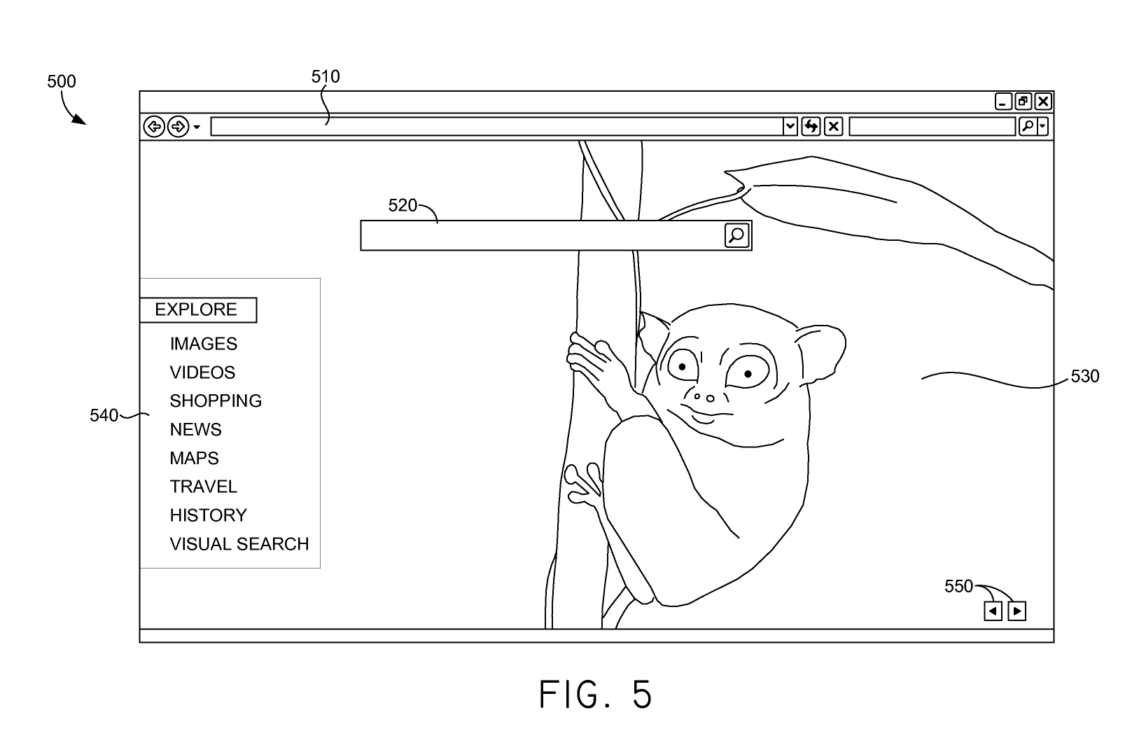

Referring now to FIG. 5, an exemplary user interface 500 that is suitable for implementing embodiments of the present invention. The exemplary user interface 500 includes an address bar 510, a search query entry field 520, a custom image 530, a navigation bar 540, and image history navigation buttons 550. It should be appreciated that this is an exemplary user interface and does not limited the scope of the present invention but is used to clarify embodiments hereof.

The user interface 500 illustrates a custom search engine home page that a user may access to perform an Internet search. The address bar 510 is well known in the art for receiving input of web page addresses or uniform resource locaters (URLs) to navigate to any given web page. The search query entry field 520 is a text field that allows a user to input a search query. As is customary, when the user executes the search, the search engine (e.g., search engine 230 of FIG. 2) will search the Internet for search results. The custom image 530 is an example of an image that may be displayed on the custom search engine home page 500. The navigation bar 540 is an example of web page links that might be available to a user from the custom search engine home page. The navigation bar 540 is not limited to the types of links listed but is merely shown as an example. The image history navigation buttons 550 allow a user to view previous custom home page images. Also, another aspect of this invention may provide trivia or facts related to the custom home page image that is selected for display. The trivia or facts may be shown in any number of ways such as pop up boxes, for example.

While embodiments of the invention are susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. One or more computer-readable storage media storing computer-useable instructions that, when used by one or more computing devices, cause the one or more computing devices to perform a method for utilizing interest indicators associated with users to customize search engine home pages, the method comprising:
receiving an indication that a user desires to access a search engine home page;
comparing one or more interest indicators associated with the user with a plurality of scheduled events, each of the plurality of scheduled events having at least one event-associated interest category associated therewith, wherein the one or more interest indicators associated with the user are organized into one or more user-associated interest categories; and
selecting an image for presentation in association with the search engine home page, the image being selected based upon a common interest category of both the at least one event-associated interest category associated with one of the plurality of scheduled events and the one or more user-associated interest categories associated with the one or more interest indicators associated with the user.

2. The one or more computer-readable storage media of claim 1, wherein the method further comprises determining that the one or more interest indicators associated with the user are so associated.

3. The one or more computer-readable storage media of claim 2, wherein the method further comprises organizing the one more interest indicators associated with the user into the one or more user-associated interest categories.

4. The one or more computer-storage media of claim 1, wherein the method further comprises generating the search engine home page having the selected image.

5. The one or more computer-storage media of claim 4, wherein the method further comprises generating one or more hotspots for presentation in association with the search engine home page, each hotspot providing access to information pertaining to the selected image.

6. The one or more computer-storage media of claim 5, wherein the information pertaining to the selected image includes one or more of facts and trivia pertaining to the common interest category.

7. The one or more computer-storage media of claim 1, wherein the one or more interest indicators associated with the user are based upon historical search behavior of the user.

8. A system for presenting search engine home pages customized based upon interest indicators associated with users, the system comprising:
a computing device associated with one or more processors and one more computer-readable storage media;
a data store coupled with the computing device; and
a search engine that receives an indication that a user desires to access a home page associated with the search engine, compares one or more user-associated interest categories associated with the user with a plurality of scheduled events to determine at least one common interest category there between, and selects an image for presentation in association with the search engine home page, the image being selected based upon the at least one common interest category.

9. The system of claim 8, wherein the data store comprises historical search information associated with the user.

10. The system of claim 8, wherein the data store comprises an event catalog that includes the plurality of scheduled events, each scheduled event having at least one associated interest category.

11. The system of claim 8, wherein the data store comprises an image store having a plurality of images configured for presentation in association with the search engine home page, each of the images being associated with at least one interest category.

12. The system of claim 8, wherein the search engine determines that a plurality of interest indicators is associated with the user.

13. The system of claim 8, wherein the search engine organizes the plurality of interest indicators into the one or more user-associated interest categories.

14. The system of claim 8, wherein the search engine associates the one or more user-associated interest categories with the user.

15. The system of claim 8, wherein the search engine generates the search engine home page having the selected image.

16. The system of claim 15, wherein the search engine home page includes one or more hotspots that provides access to information pertaining to the selected image.

17. One or more computer-readable storage media storing computer-useable instructions that, when used by one or more computing devices, cause the one or more computing devices to perform a method for utilizing interest indicators associated with users to customize search engine home pages, the method comprising:
receiving an indication that a user desires to access a search engine home page;
determining that one or more interest indicators associated with the user is available;
determining one or more interest categories for the user based upon the one or more interest indicators associated with the user;
comparing the one or more interest categories for the user with an event catalog, wherein the event catalog includes a plurality of events, each of the plurality of events being associated with at least one interest category;
determining that one of the one or more interest categories for the user and one of the at least one interest categories associated with one of the plurality of events is a common interest category; and
selecting an image for presentation in association with the search engine home page, the image being selected based upon the at least one common interest category.

18. The one or more computer-storage media of claim 17, wherein the method further comprises generating the search engine home page having the selected image.

19. The one or more computer-storage media of claim 17, wherein the method further comprises generating one or more hotspots for presentation in association with the search engine home page, each hotspot providing access to information pertaining to the selected image.

20. The one or more computer-storage media of claim 17, wherein the one or more interest indicators associated with the user are based upon historical search behavior of the user.
